(19) United States
(12) Patent Application Publication
(10) Pub. No.: US 2012/0163207 A1
(43) Pub. Date: Jun. 28, 2012

(54) SPEED-ADAPTIVE CHANNEL QUALITY INDICATOR (CQI) ESTIMATION

(75) Inventors: Aditya Dua, San Jose, CA (US); Feng Lu, Sunnyvale, CA (US); Vignesh Sethuraman, San Diego, CA (US)

(73) Assignee: QUALCOMM INCORPORATED, San Diego, CA (US)

(21) Appl. No.: 13/253,039

(22) Filed: Oct. 4, 2011

Related U.S. Application Data
(60) Provisional application No. 61/426,581, filed on Dec. 23, 2010.

(51) Int. Cl. H04W 24/00

(52) U.S. Cl. 370/252

(57) ABSTRACT

A method, apparatus, computer program product, and processing system for generating a channel quality indicator (CQI) adapted according to the speed of a moving user equipment (UE). A CQI can be generated by mapping a calculated signal-to-noise ratio (SNR) to a CQI value. The SNR corresponds to a signal power and a noise power of a received pilot signal. The signal power and the noise power may be generated utilizing respective infinite impulse response (IIR) filters having filter coefficients chosen in accordance with the speed at which the UE moves. Selection of the filter coefficients can be made in accordance with a continuous function or a discontinuous function utilizing a threshold, and may utilize hysteresis.

### CROSS-REFERENCE TO RELATED APPLICATIONS

This application claims priority to and the benefit of provisional patent application No. 61/426,581, filed in the United States Patent and Trademark Office on Dec. 23, 2010, the entire content of which is incorporated herein by reference.

### BACKGROUND

1. Field

Aspects of the present disclosure relate generally to wireless communication systems, and more particularly, to channel quality feedback for adaptive transmissions in a wireless communication system.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications. For example, one integral component of 3G and 4G wireless technologies such as UMTS and its later-developed cousin LTE is adaptive transmissions based on channel quality feedback. In these wireless communication systems, user equipment (UE) such as a cell phone, tablet, or a laptop data card estimates certain characteristics of the downlink channel and provides an uplink transmission including feedback such as a Channel Quality Indicator (CQI). The CQI generally provides to a base station (Node B) the UE's estimation of the downlink channel quality. The Node B in turn may use the CQI feedback information received on the uplink to dynamically allocate resources (e.g. OVSF codes and power in HSPA+) on future downlink transmissions.

To help UEs to perform downlink channel measurements and coherent demodulation, the Node B typically transmits a pilot channel bearing a known training sequence on the downlink (e.g. CPICH in HSPA+). A typical CQI estimation procedure at the UE involves estimating signal and noise powers from demodulated pilot symbols, computing a signal-to-noise ratio (SNR) on the pilot channel from the signal and noise power estimates, and finally translating this SNR measurement into a CQI value to be reported to the Node B on the uplink.

However, because improvements to the estimation of the channel quality can provide improved link level data throughput, further development efforts to enable an improved CQI are desired.

### SUMMARY

Aspects of the present disclosure provide methods, apparatuses, computer program products, and processing systems capable of providing a channel quality indicator (CQI) that is a function of the speed at which the user equipment (UE) moves. Because changes in the speed of the moving UE can affect characteristics of the channel, alterations to the CQI in accordance with the speed can be utilized by the Node B to better tailor future downlink transmissions and improve the link-layer throughput of the air interface.

In one aspect, the disclosure provides a method of wireless communication for user equipment. Here, the method includes generating a signal power estimate corresponding in part to a speed at which the user equipment moves, generating a noise power estimate corresponding in part to the speed at which the user equipment moves, generating a channel quality indicator corresponding to the signal power estimate and the noise power estimate, and transmitting the channel quality indicator.

Another aspect of the disclosure provides an apparatus for wireless communication. Here, the apparatus includes means for generating a signal power estimate corresponding in part to a speed at which the apparatus moves, means for generating a noise power estimate corresponding in part to the speed at which the apparatus moves, means for generating a channel quality indicator corresponding to the signal power estimate and the noise power estimate, and means for transmitting the channel quality indicator.

Yet another aspect of the disclosure provides a computer program product for user equipment including a computer-readable medium. Here, the computer-readable medium includes instructions for causing a computer to generate a signal power estimate corresponding in part to a speed at which the user equipment moves, instructions for causing a computer to generate a noise power estimate corresponding in part to the speed at which the user equipment moves, instructions for causing a computer to generate a channel quality indicator corresponding to the signal power estimate and the noise power estimate, and instructions for causing a computer to transmit the channel quality indicator.

Still another aspect of the disclosure provides an apparatus for wireless communication including at least one processor and a memory coupled to the at least one processor. Here, the at least one processor is configured to generate a signal power estimate corresponding in part to a speed at which the apparatus moves, to generate a noise power estimate corresponding in part to the speed at which the apparatus moves, to generate a channel quality indicator corresponding to the signal power estimate and the noise power estimate, and to transmit the channel quality indicator.

These and other aspects of the invention will become more fully understood upon a review of the detailed description, which follows.

### BRIEF DESCRIPTION OF THE DRAWINGS

FIG. 1 is a block diagram illustrating an example of a hardware implementation for an apparatus employing a processing system.

FIG. 2 is a conceptual diagram illustrating an example of a radio protocol architecture for the user and control plane.

FIG. 3 is a block diagram conceptually illustrating an example of a telecommunications system.

FIG. 4 is a block diagram conceptually illustrating an example of a Node B in communication with a UE in a telecommunications system.

FIG. 5 is a conceptual diagram illustrating an example of an access network.

FIG. 6 is a block diagram illustrating an apparatus for generating a CQI in accordance with the speed at which a UE moves.

FIG. 7 is a flow chart illustrating a process for generating a CQI in accordance with the speed at which a UE moves.

FIG. 8 is a flow chart illustrating a process for selecting a filter coefficient utilizing hysteresis.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

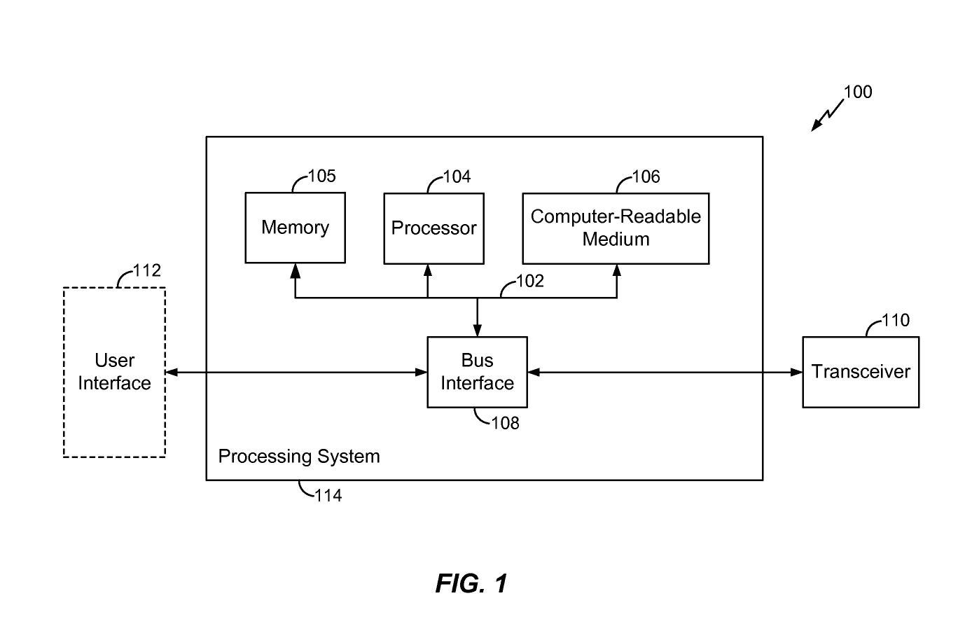

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, a memory 105, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

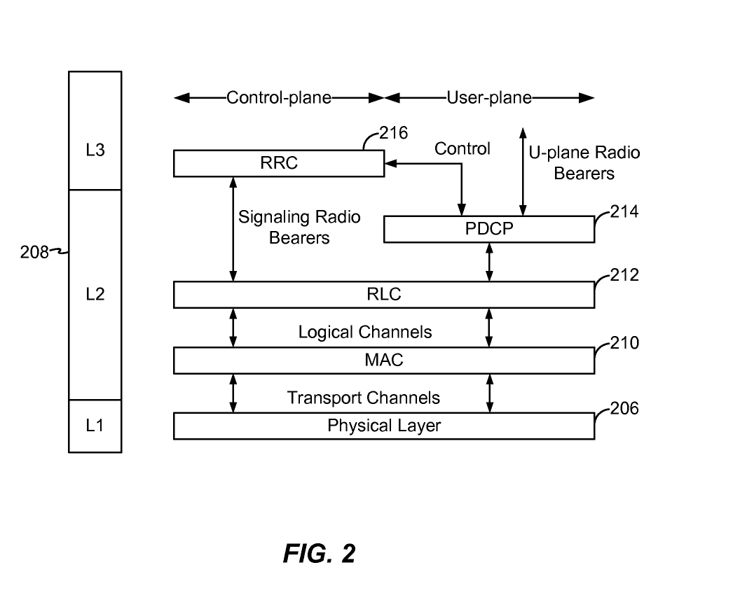

In a wireless telecommunication system, the radio protocol architecture between a mobile device and a cellular network may take on various forms depending on the particular application. An example for a 3GPP high-speed packet access (HSPA) system will now be presented with reference to FIG. 2, illustrating an example of the radio protocol architecture for the user and control planes between user equipment (UE) and a base station, commonly referred to as a Node B. Here, the user plane or data plane carries user traffic, while the control plane carries control information, i.e., signaling.

Turning to FIG. 2, the radio protocol architecture for the UE and Node B is shown with three layers: Layer 1, Layer 2, and Layer 3. Layer 1 is the lowest layer and implements various physical layer signal processing functions. Layer 1 will be referred to herein as the physical layer 206. The data link layer, called Layer 2 (L2 layer) 208 is above the physical layer 206 and is responsible for the link between the UE and Node B over the physical layer 206.

At Layer 3, the RRC layer 216 handles the control plane signaling between the UE and the Node B. RRC layer 216 includes a number of functional entities for routing higher layer messages, handling broadcast and paging functions, establishing and configuring radio bearers, etc.

In the illustrated air interface, the L2 layer 208 is split into sublayers. In the control plane, the L2 layer 208 includes two sublayers: a medium access control (MAC) sublayer 210 and a radio link control (RLC) sublayer 212. In the user plane, the L2 layer 208 additionally includes a packet data convergence protocol (PDCP) sublayer 214. Although not shown, the UE may have several upper layers above the L2 layer 208 including a network layer (e.g., IP layer) that is terminated at a PDN gateway on the network side, and an application layer that is terminated at the other end of the connection (e.g., far end UE, server, etc.).

The PDCP sublayer 214 provides multiplexing between different radio bearers and logical channels. The PDCP sublayer 214 also provides header compression for upper layer data packets to reduce radio transmission overhead, security by ciphering the data packets, and handover support for UEs between Node Bs.

The RLC sublayer 212 provides segmentation and reassembly of upper layer data packets, retransmission of lost data packets, and reordering of data packets to compensate for out-of-order reception due to a hybrid automatic repeat request (HARQ).

The MAC sublayer 210 provides multiplexing between logical and transport channels. The MAC sublayer 210 is also responsible for allocating the various radio resources (e.g., resource blocks) in one cell among the UEs. The MAC sublayer 210 is also responsible for HARQ operations.

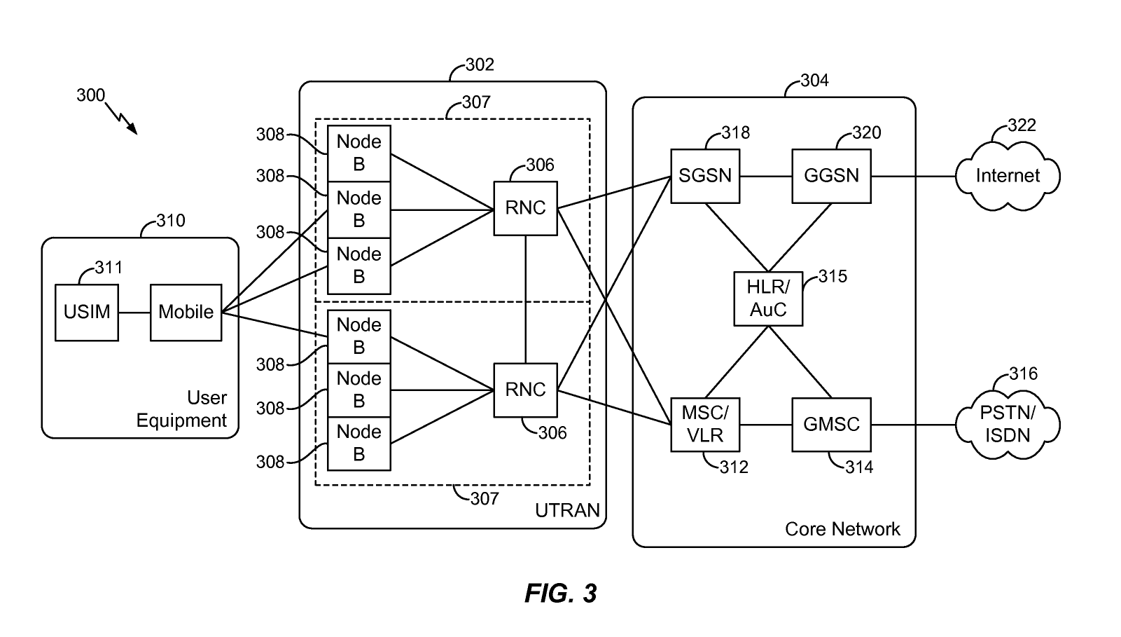

Referring now to FIG. 3, by way of example and without limitation, various aspects of the present disclosure are illustrated with reference to a Universal Mobile Telecommunications System (UMTS) system 300 employing a W-CDMA air interface, which may utilize HSPA. A UMTS network includes three interacting domains: a Core Network (CN) 304, a UMTS Terrestrial Radio Access Network (UTRAN) 302, and User Equipment (UE) 310. In this example, the UTRAN 302 may provide various wireless services including telephony, video, data, messaging, broadcasts, and/or other services. The UTRAN 302 may include a plurality of Radio Network Subsystems (RNSs) such as an RNS 307, each controlled by a respective Radio Network Controller (RNC) such as an RNC 306. Here, the UTRAN 302 may include any number of RNCs 306 and RNSs 307 in addition to the illustrated RNCs 306 and RNSs 307. The RNC 306 is an apparatus responsible for, among other things, assigning, reconfiguring and releasing radio resources within the RNS 307. The RNC 306 may be interconnected to other RNCs (not shown) in the UTRAN 302 through various types of interfaces such as a direct physical connection, a virtual network, or the like, using any suitable transport network.

Communication between a UE 310 and a Node B 308 may be considered as including a physical (PHY) layer and a medium access control (MAC) layer. Further, communication between a UE 310 and an RNC 306 by way of a respective Node B 308 may be considered as including a radio resource control (RRC) layer.

The geographic region covered by the RNS 307 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 308 are shown in each RNS 307; however, the RNSs 307 may include any number of wireless Node Bs. The Node Bs 308 provide wireless access points to a core network (CN) 304 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 310 may further include a universal subscriber identity module (USIM) 311, which contains a user's subscription information to a network. For illustrative purposes, one UE 310 is shown in communication with a number of the Node Bs 308. The downlink (DL), also called the forward link, refers to the communication link from a Node B 308 to a UE 310, and the uplink (UL), also called the reverse link, refers to the communication link from a UE 310 to a Node B 308.

The core network 304 interfaces with one or more access networks, such as the UTRAN 302. As shown, the core network 304 is a GSM core network. However, as those skilled in the art will recognize, the various concepts presented throughout this disclosure may be implemented in a RAN, or other suitable access network, to provide UEs with access to types of core networks other than GSM networks.

The illustrated GSM core network 304 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains.

In the illustrated example, the core network 304 supports circuit-switched services with a MSC 312 and a GMSC 314. In some applications, the GMSC 314 may be referred to as a media gateway (MGW). One or more RNCs, such as the RNC 306, may be connected to the MSC 312. The MSC 312 is an apparatus that controls call setup, call routing, and UE mobility functions. The MSC 312 also includes a visitor location register (VLR) that contains subscriber-related information for the duration that a UE is in the coverage area of the MSC 312. The GMSC 314 provides a gateway through the MSC 312 for the UE to access a circuit-switched network 316. The GMSC 314 includes a home location register (HLR) 315 containing subscriber data, such as the data reflecting the details of the services to which a particular user has subscribed. The HLR is also associated with an authentication center (AuC) that contains subscriber-specific authentication data. When a call is received for a particular UE, the GMSC 314 queries the HLR 315 to determine the UE's location and forwards the call to the particular MSC serving that location.

The illustrated core network 304 also supports packet-data services with a serving GPRS support node (SGSN) 318 and a gateway GPRS support node (GGSN) 320. GPRS, which stands for General Packet Radio Service, is designed to provide packet-data services at speeds higher than those available with standard circuit-switched data services. The GGSN 320 provides a connection for the UTRAN 302 to a packet-based network 322. The packet-based network 322 may be the Internet, a private data network, or some other suitable packet-based network. The primary function of the GGSN 320 is to provide the UEs 310 with packet-based network connectivity. Data packets may be transferred between the GGSN 320 and the UEs 310 through the SGSN 318, which performs primarily the same functions in the packet-based domain as the MSC 312 performs in the circuit-switched domain.

The UMTS air interface may be a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such DS-CDMA technology and additionally calls for a frequency division duplexing (FDD). FDD uses a different carrier frequency for the uplink (UL) and downlink (DL) between a Node B 308 and a UE 310. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface.

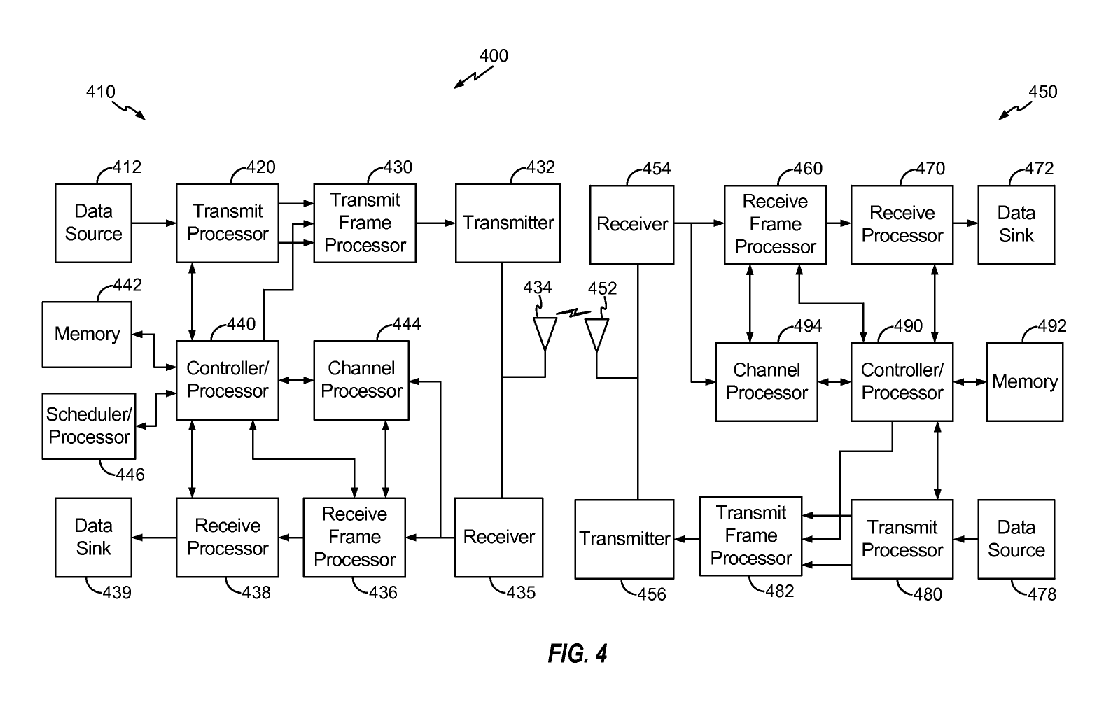

FIG. 4 is a block diagram illustrating further detail of an exemplary Node B 410 in communication with an exemplary UE 450 over the exemplary W-CDMA air interface, where the Node B 410 may be the Node B 308 in FIG. 3, and the UE 450 may be the UE 310 in FIG. 3. In the downlink direction, a transmit processor 420 may receive data from a data source 412 and control signals from a controller/processor 440. The transmit processor 420 provides various signal processing functions for the data and control signals, as well as reference signals (e.g., pilot signals). For example, the transmit processor 420 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 444 may be used by a controller/processor 440 to determine the coding, modulation, spreading, and/or scrambling schemes for the transmit processor 420. These channel estimates may be derived from a reference signal transmitted by the UE 450 or from feedback from the UE 450. The symbols generated by the transmit processor 420 are provided to a transmit frame processor 430 to create a frame structure. The transmit frame processor 430 creates this frame structure by multiplexing the symbols with information from the controller/processor 440, resulting in a series of frames. The frames are then provided to a transmitter 432, which provides various signal conditioning functions including amplifying, filtering, and modulating the frames onto a carrier for downlink transmission over the wireless medium through antenna 434. The antenna 434 may include one or more antennas, for example, including beam steering bidirectional adaptive antenna arrays or other similar beam technologies.

At the UE 450, a receiver 454 receives the downlink transmission through an antenna 452 and processes the transmission to recover the information modulated onto the carrier. The information recovered by the receiver 454 is provided to a receive frame processor 460, which parses each frame, and provides information from the frames to a channel processor 494 and the data, control, and reference signals to a receive processor 470. The channel processor may generate a channel estimate to assist with the decoding of the downlink, and may also assist with the generation of a channel quality indicator (CQI) to be transmitted to the Node B 410 as feedback. The receive processor 470 performs the inverse of the processing performed by the transmit processor 420 in the Node B 410. More specifically, the receive processor 470 demodulates the received signal by descrambling and despreading the symbols, and then determines the most likely signal constellation points transmitted by the Node B 410 based on the modulation scheme. These soft decisions may be based on channel estimates computed by the channel processor 494. The soft decisions are then decoded and deinterleaved to recover the data, control, and reference signals. The CRC codes are then checked to determine whether the frames were successfully decoded. The data carried by the successfully decoded frames will then be provided to a data sink 472, which represents applications running in the UE 450 and/or various user interfaces (e.g., display). Control signals carried by successfully decoded frames will be provided to a controller/processor 490. When frames are unsuccessfully decoded by the receiver processor 470, the controller/processor 490 may also use an acknowledgement (ACK) and/or negative acknowledgement (NACK) protocol to support retransmission requests for those frames.

In the uplink, data from a data source 478 and control signals from the controller/processor 490 are provided to a transmit processor 480. The data source 478 may represent applications running in the UE 450 and various user interfaces (e.g., keyboard). Similar to the functionality described in connection with the downlink transmission by the Node B 410, the transmit processor 480 provides various signal processing functions including CRC codes, coding and interleaving to facilitate FEC, mapping to signal constellations, spreading with OVSFs, and scrambling to produce a series of symbols. Channel estimates, derived by the channel processor 494 from a reference signal transmitted by the Node B 410 or from feedback contained in the midamble transmitted by the Node B 410, may be used to select the appropriate coding, modulation, spreading, and/or scrambling schemes. The symbols produced by the transmit processor 480 will be provided to a transmit frame processor 482 to create a frame structure. The transmit frame processor 482 creates this frame structure by multiplexing the symbols with information from the controller/processor 490, resulting in a series of frames. The frames are then provided to a transmitter 456, which provides various signal conditioning functions including amplification, filtering, and modulating the frames onto a carrier for uplink transmission over the wireless medium through the antenna 452.

The uplink transmission is processed at the Node B 410 in a manner similar to that described in connection with the receiver function at the UE 450. A receiver 435 receives the uplink transmission through the antenna 434 and processes the transmission to recover the information modulated onto the carrier. The information recovered by the receiver 435 is provided to a receive frame processor 436, which parses each frame, and provides information from the frames to the channel processor 444 and the data, control, and reference signals to a receive processor 438. The receive processor 438 performs the inverse of the processing performed by the transmit processor 480 in the UE 450. The data and control signals carried by the successfully decoded frames may then be provided to a data sink 439 and the controller/processor, respectively. If some of the frames were unsuccessfully decoded by the receive processor, the controller/processor 440 may also use an acknowledgement (ACK) and/or negative acknowledgement (NACK) protocol to support retransmission requests for those frames.

The controller/processors 440 and 490 may be used to direct the operation at the Node B 410 and the UE 450, respectively. For example, the controller/processors 440 and 490 may provide various functions including timing, peripheral interfaces, voltage regulation, power management, and other control functions. The computer readable media of memories 442 and 492 may store data and software for the Node B 410 and the UE 450, respectively. A scheduler/processor 446 at the Node B 410 may be used to allocate resources to the UEs and schedule downlink and/or uplink transmissions for the UEs.

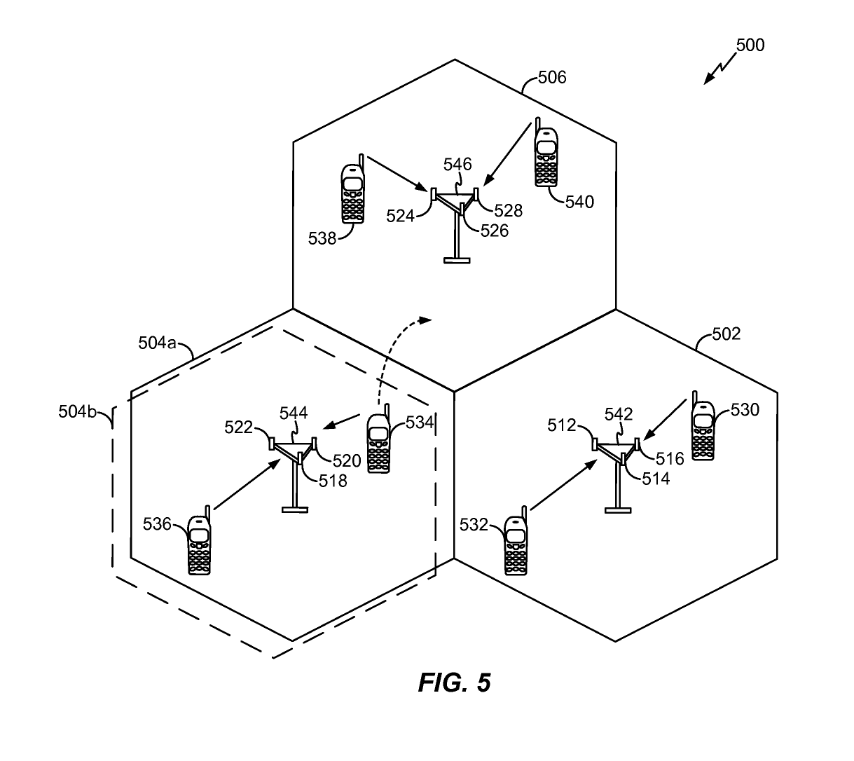

The various concepts presented throughout this disclosure may be implemented across a broad variety of telecommunication systems, network architectures, and communication standards. Referring to FIG. 5, by way of example and without limitation, a simplified access network 500 is illustrated. Here, the access network 500 may be the UTRAN 302 illustrated in FIG. 3, and may utilize any suitable air interface protocol such as W-CDMA, and may further implement HSPA. The illustrated access network 500 includes multiple cellular regions (cells), including cells 502, 504, and 506, each of which may include one or more sectors. Cells may be defined geographically, e.g., by coverage area, and/or may be defined in accordance with a carrier frequency, scrambling code, etc. That is, the illustrated geographically-defined cells 502, 504, and 506 may each be further divided into a plurality of cells, e.g., by utilizing different carrier frequencies or scrambling codes. For example, cell 504a may utilize a first carrier frequency or scrambling code, and cell 504b, while in the same geographic region and served by the same Node B 544, may be distinguished by utilizing a second carrier frequency or scrambling code.

In a cell that is divided into sectors, the multiple sectors within a cell can be formed by groups of antennas with each antenna responsible for communication with UEs in a portion of the cell. For example, in cell 502, antenna groups 512, 514, and 516 may each correspond to a different sector. In cell 504, antenna groups 518, 520, and 522 each correspond to a different sector. In cell 506, antenna groups 524, 526, and 528 each correspond to a different sector.

The cells 502, 504 and 506 may include several UEs that may be in communication with one or more sectors of each cell 502, 504 or 506. For example, UEs 530 and 532 may be in communication with Node B 542, UEs 534 and 536 may be in communication with Node B 544, and UEs 538 and 540 may be in communication with Node B 546. Here, each Node B 542, 544, 546 is configured to provide an access point to a core network 204 (see FIG. 2) for all the UEs 530, 532, 534, 536, 538, 540 in the respective cells 502, 504, and 506.

For example, during a call with cell 504a, or at any other time, the UE 536 may monitor various parameters of the cell 504a as well as various parameters of neighboring cells such as cells 502, 504b, and 506. Further, depending on the quality of these parameters, the UE 536 may maintain communication with one or more of the neighboring cells. During this time, the UE 536 may maintain an Active Set, that is, a list of cells that the UE 536 simultaneously is connected to (i.e., the UTRA cells that are currently assigning a downlink dedicated physical channel DPCH or fractional downlink dedicated physical channel F-DPCH to the UE 536 may constitute the Active Set).

In a Serving Cell Change (SCC) procedure, the UE 536 may request that the serving cell be changed from the currently serving source cell to a target cell. This request is sent to the UTRAN through a so-called “event 1D” message. The UTRAN and the UE exchange several messages and when the procedure is complete the UE is served by the target cell.

In Release 5 of the 3GPP family of standards, high-speed downlink packet access (HSDPA) was introduced, and in Release 6, high-speed uplink packet access (HSUPA, also referred to as enhanced uplink or EUL) was introduced. Together, along with continued enhancements in later 3GPP standards, HSUPA and HSDPA form what is frequently called high-speed packet access (HSPA).

The HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding.

In particular, HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE provides feedback to the Node B over the HS-DPCCH to indicate whether it correctly decoded a packet on the downlink.

HS-DPCCH further includes feedback signaling from the UE to assist the Node B in taking the right decision in terms of modulation and coding scheme, this feedback signaling including a channel quality indicator (CQI).

That is, in an HSDPA system, the UE generally monitors and performs measurements of certain parameters of the downlink to determine the quality of that link. Based on these measurements the UE can provide feedback to the Node B on the HS-DPCCH, this feedback including the CQI. In general, the CQI is transmitted every few milliseconds when the UE is in its CELL_DCH state to indicate to the Node B an estimated transport block size (TBS), coding format, modulation type, etc., to use for downlink transmissions such that the UE can receive those transmissions with a reasonable block error rate, e.g., an error rate of less than 10%. Of course, any suitable protocol for the information transmitted on a CQI may be utilized within the scope of the present disclosure. When it receives the CQI, the Node B may adapt the link in accordance with the feedback information and provide subsequent packets to the UE on downlink transmissions having a TBS, modulation type, coding format, etc., based on the CQI reported from the UE. Further, CQI reports from a number of UEs served by a Node B can be used by the network to estimate the maximum air interface capacity for the purpose of scheduling traffic for all UEs.

Thus, link adaptation performance for HSDPA and related services depends in part on the robustness and effectiveness of the CQI measurements. Improvements in the CQI can translate into link level performance improvements for HSDPA services, which can in turn result in system level performance improvements. Therefore, some aspects of the present disclosure provide a procedure to generate the CQI, accounting for motion of the UE.

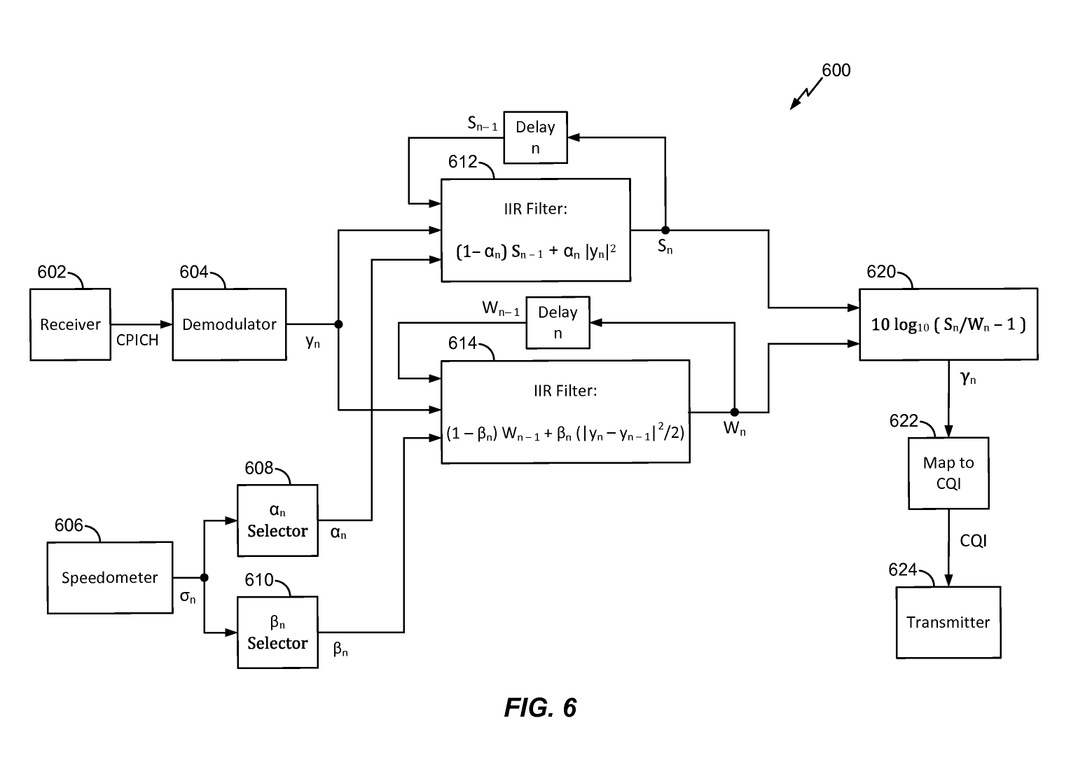

FIG. 6 is a simplified block diagram illustrating an exemplary apparatus 600 for wireless communication, in which a CQI corresponding to the speed of the UE is generated and transmitted to a Node B. Broadly, the apparatus 600 receives and demodulates pilot symbols, which may be carried on a common pilot channel (CPICH), and estimates the signal and noise powers corresponding to those symbols. Based on these estimates a signal-to-noise ratio (SNR) may be determined for the pilot channel, and finally, this SNR may be translated into the CQI to be reported to the Node B.

In an aspect of the disclosure, the apparatus 600 may be configured to perform at least a portion of the relevant calculations in accordance with a discrete time interval n. That is, measurements of the speed and generation of corresponding speed-dependent parameters may be performed at each time n, such that the respective values are indexed by n.

In some aspects, the apparatus 600 may include one or more processing system(s) 114 as illustrated in FIG. 1. In some aspects, the apparatus 600 may be a portion of a UE such as the UE 310 illustrated in FIG. 3 or the UE 450 illustrated in FIG. 4. For example, the apparatus 600 includes a receiver 602 and a demodulator 604. Here, the receiver 602 is configured to receive a downlink and to provide a common pilot channel (CPICH) to the demodulator 604, and the demodulator 604 is configured to demodulate the CPICH and to provide a received pilot symbol at a time n, denoted as yₙ. In some aspects of the disclosure, the receiver 602 and the demodulator 604 may be the same as the receiver 454 and the receive processor 470 (see FIG. 4), respectively. Further, the apparatus 600 includes a transmitter 624. Here, the transmitter 624 is configured to transmit the CQI, e.g., over the HS-DPCCH. In some aspects of the disclosure, the transmitter 624 may be the same as the transmitter 456 (see FIG. 4). Additional blocks illustrated in FIG. 6 may be implemented by the controller/processor 490 (see FIG. 4), or by any suitable processing system 114 (see FIG. 1). Of course, the block diagram illustrated in FIG. 6 is merely illustrative in nature, and any suitable apparatus, processing system, or other means for performing the described functions may be utilized in various aspects of the present disclosure.

The apparatus 600 includes a speedometer 606 for determining the speed σ at which the UE moves. Here, the speed σ may be indexed by the time n, such that the indexed speed σₙ corresponds to the instantaneous speed at time n. In various aspects of the disclosure, the speedometer 606 may be included within the UE, while in other aspects of the disclosure, the speedometer 606 may be external to the UE, and the speed information σ may be provided to the UE by way of the data source 478 (see FIG. 4). Further, the speedometer 606 may obtain an estimate of the speed σ at which the UE moves by any suitable method, such as directly tracking movement of the UE through physical measurements from motion sensors, GPS, etc., or indirectly tracking movement of the UE, e.g., utilizing a Kalman filtering approach.

Based on the instantaneous speed σₙ, a signal power filter coefficient selector 608 and a noise power coefficient selector 610 may respectively select a signal power filter coefficient αₙ and a noise power filter coefficient βₙ. That is, in an aspect of the present disclosure, to at least partially suppress estimation noise and to increase the reliability of the estimation, the signal and noise power estimates may be filtered prior to computation of the SNR. For example, smoothing of the signal and noise power estimates utilizing a suitable filter can improve the quality of the estimates. Here, the effectiveness of the respective signal power estimate filter and noise power estimate filter may vary in different scenarios of interest, and the same filter coefficients can produce better or worse results in different scenarios. For example, the best choice of filter coefficients can depend on the velocity or speed of a moving UE, multipath characteristics of the downlink transmission, the ambient noise/interference level, etc. Thus, adaptively selecting filter coefficients αₙ and βₙ based on changes in conditions that may alter the effectiveness of the CQI, such as the instantaneous speed σₙ, may result in an improved link-level throughput.

Thus, in a further aspect of the present disclosure, filter coefficients αₙ and βₙ utilized as a part of the process for the generation of the CQI may adaptively be selected based on the instantaneous speed σₙ of the moving UE.

For example, in one aspect of the present disclosure, a signal power filter 612 may utilize the signal power filter coefficient αₙ and pilot symbol amplitude yₙ to estimate a signal power at time n, denoted as Sₙ. For example, the signal power filter 612 may square the amplitude of the received pilot symbol yₙ and then filter with a one-pole infinite impulse response (IIR) filter having a pole located at 1−αₙ. That is:

Sₙ=(1−αₙ)Sₙ₋₁+αₙ|yₙ|². (Equation 1)

Here, the signal power filter coefficient αₙ may be adaptively selected based on changes in conditions that may alter the effectiveness of the resulting CQI, e.g., in accordance with the speed of the UE at time n.

Further, in accordance with this example, a noise power filter 614 may utilize the noise power coefficient βₙ and the pilot symbol amplitude yₙ to estimate a noise power at time n, denoted as Wₙ. For example, the noise power filter 614 may compute the power in successive differences of the pilot symbol sequence, and then filter this quantity with a one-pole IIR filter having a pole located at 1−βₙ. That is:

Wₙ=(1−βₙ)Wₙ₋₁+βₙ(|yₙ−yₙ₋₁|²/2). (Equation 2)

Here, as above, the noise power filter coefficient βₙ may be adaptively selected based on changes in conditions that may alter the effectiveness of the resulting CQI, e.g., in accordance with the speed of the UE at time n.

In a further aspect of the disclosure, a signal-to-noise ratio generator 620 may utilize the signal power estimate Sₙ at time n and the noise power estimate Wₙ at time n to calculate an estimated SNRₙ at time n, denoted γₙ, as follows:

γₙ=10 log₁₀(Sₙ/Wₙ−1). (Equation 3)

Here, the estimated SNR γₙ may be in units of dB. Once the estimated SNR γₙ is obtained, it may be sent to a CQI mapping block 622 for mapping the SNR γₙ to a CQI value. In turn, the CQI value may be provided to the transmitter 624 to be transmitted on the uplink, e.g., on the HS-DPCCH. The mapping of the estimated SNR γₙ to the CQI by block 622 can utilize any suitable mapping protocol, the details of which are generally implementation-specific and are not discussed in detail herein. However, in some examples a lookup table translating each value of the estimated SNR γₙ to a suitable CQI value may be utilized.

The characteristic equations of the one-pole IIR filters 612 and 614 described above are only provided as an example. Those skilled in the art will comprehend that in general, other filtering structures such as higher order IIR filters including more than one pole, FIR filters, or any other suitable filter may be utilized to filter the signal power estimate Sₙ and noise power estimate Wₙ.

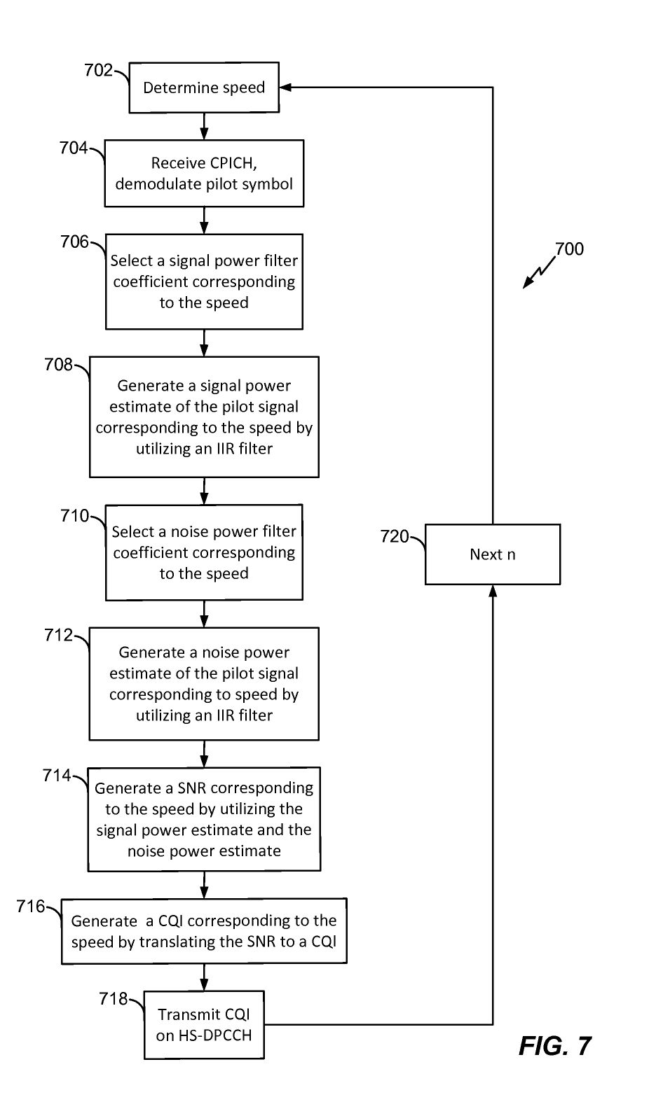

FIG. 7 is a flow chart illustrating an exemplary process 700 for wireless communication in accordance with some aspects of the present disclosure. In various examples, different portions of the process 700 may be implemented by the processing system 114 illustrated in FIG. 1; by the UE 310 illustrated in FIG. 3 or the UE 450 illustrated in FIG. 4; or the apparatus 600 illustrated in FIG. 6. However, those skilled in the art will comprehend that the various process steps illustrated in process 700 may be carried out by any suitable processing system, apparatus, or means for performing the described functions.

In block 702, the process may determine the speed at which the UE moves. Here, the determination of the speed of the UE may be performed by the speedometer 606 illustrated in FIG. 6, or by any suitable apparatus for determining speed of the UE. Further, the determination of the speed of the UE may be directly performed by measurements of the position of the UE over time, or indirectly performed, as described above. In some aspects of the disclosure, the speed of the UE may be determined externally, and information corresponding to the speed of the UE may be provided to the UE from the external source.

In block 704, the process may receive a downlink including the common pilot channel CPICH, and may demodulate the signal to obtain a pilot symbol yₙ. In some examples the receiving and demodulating in block 704 may be performed by the receiver 602 and the demodulator 604 illustrated in FIG. 6, however any suitable apparatus for receiving and demodulating the pilot channel CPICH may be utilized.

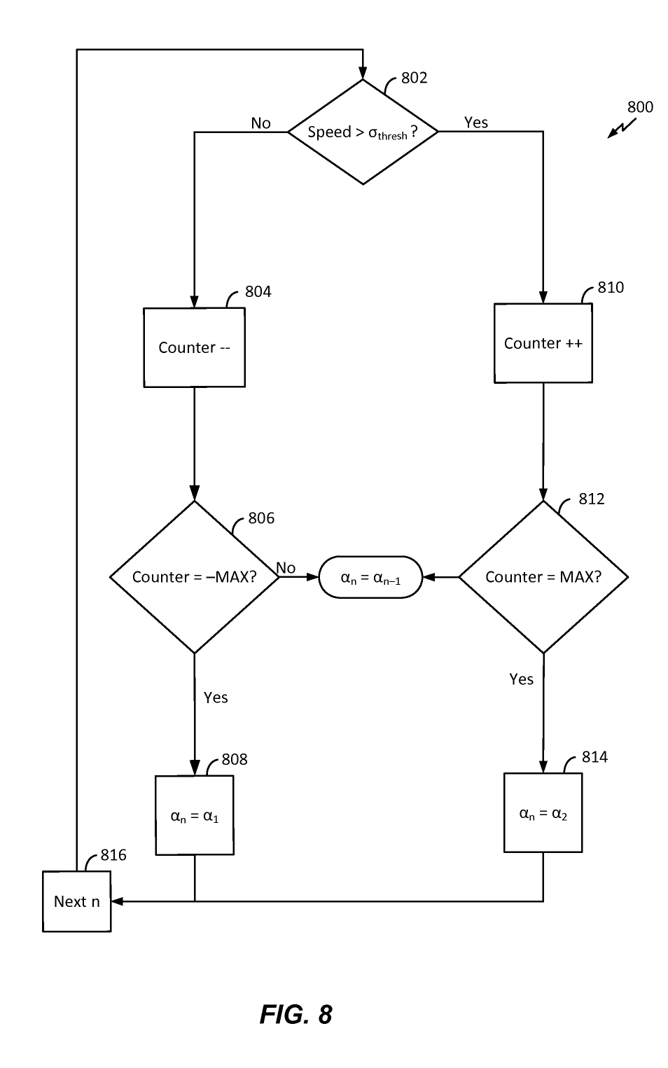

In block 706, the process may select a signal power filter coefficient αₙ corresponding to the speed at which the UE moves at time n. One exemplary process for utilizing a threshold with hysteresis to select the filter coefficient is illustrated in FIG. 8, although any suitable process for selecting the filter coefficient may be utilized in accordance with various aspects of the present disclosure. In block 708, the process may generate a signal power estimate Sₙ of the pilot signal corresponding to the speed by utilizing an IIR filter. For example, the signal power filter 612 illustrated in FIG. 6 may be utilized to generate the signal power estimate.

In block 710, the process may select a noise power filter coefficient βₙ corresponding to the speed at which the UE moves at time n. One exemplary process for utilizing a threshold with hysteresis to select the filter coefficient is illustrated in FIG. 8, although any suitable process for selecting the filter coefficient may be utilized in accordance with various aspects of the present disclosure. In block 712, the process may generate a noise power estimate Wₙ of the pilot signal corresponding to the speed by utilizing an IIR filter. For example, the noise power filter 614 illustrated in FIG. 6 may be utilized to generate the noise power estimate Wₙ.

In block 714, the process may generate an SNR estimate γₙ corresponding to the speed at which the UE moves at time N, utilizing the signal power estimate Sₙ and the noise power estimate Wₙ. For example, the signal-to-noise ratio generator 620 may be utilized to generate the SNR estimate γₙ. In block 716, the SNR estimate γₙ may be utilized to generate a CQI corresponding to the speed by translating the SNR estimate γₙ to a CQI value. For example, the CQI mapping block 622 may be utilized to translate the SNR to the CQI value. In block 718, the process may transmit the CQI value on an uplink transmission as a portion of the HS-DPCCH transmission. For example, the transmission of the CQI may be implemented by the transmitter 624 illustrated in FIG. 6.

In an aspect of the disclosure, the process 700 illustrated in FIG. 7 may be repeated each time interval n. That is, in block 720, the process may wait one time interval n, and then repeat the process 700, generating a new CQI value corresponding to the next value of n. This way, each transmission of a CQI value at each interval n may correspond to the instantaneous speed σₙ of at which the UE moves.

Thus, returning now to FIG. 6, those of ordinary skill in the art will comprehend that an appropriate selection at time n of the signal power filter coefficient αₙ by the signal power filter coefficient selector 608 and the noise power filter coefficient βₙ by the noise power coefficient selector 610 may improve the effectiveness of the CQI value transmitted by the transmitter 624. In some examples, the signal power filter coefficient αₙ and the noise power filter coefficient βₙ may be the same. That is, in some aspects of the present disclosure a common filter coefficient φₙ may be utilized for generating both the signal power estimate Sₙ and the noise power estimate Wₙ. (e.g., where αₙ=βₙ=φₙ). Of course, this equality is not necessary and different coefficients may be utilized in a particular implementation.

In an aspect of the present disclosure, the choice of the filter coefficients αₙ and βₙ by the signal power filter coefficient selector 608 and the noise power filter coefficient selector 610 may correspond to a function of the speed or velocity of the UE. While the scope of the present disclosure is not limited to any particular relationship between the respective filter coefficients αₙ and βₙ and the speed or velocity of the UE, some exemplary relationships between these values are provided below. Those skilled in the art will recognize that the provided relationships are exemplary in nature, and any suitable function of the speed or velocity may be utilized to choose the filter coefficients αₙ and βₙ.

In one aspect of the disclosure, values for the filter coefficients αₙ and βₙ can be chosen as a continuous or discontinuous function of a speed at which a UE is moving at time n. For example, an equation for determining a filter coefficient can be as simple as multiplying the speed at which the UE is moving by a constant value; adding an offset to the speed or to a multiple of the speed; a geometric equation using a power of the speed; or any combination of the above. Of course, other continuous functions may be utilized within the scope of the instant disclosure. In another aspect of the disclosure, a discontinuous function for determining a filter coefficient can be used, e.g., wherein values for the filter coefficient at a particular time n can be chosen to classify all UE speeds into two or more categories. For example, a first value for the signal power filter coefficient αₙ can be selected when the UE is known to be moving at a low speed, e.g., below a suitable threshold, and a second value for the signal power filter coefficient αₙ can be selected when the UE is known to be moving at a high speed, e.g., above the threshold. Of course, some examples may include more than one discontinuity and utilize more than one threshold, and any number of threshold values for determining a discontinuous function for a value of a filter coefficient can be used within the scope of the present disclosure.

In the provided example, the filter coefficients αₙ and βₙ are indexed by the time n. In some aspects of the disclosure, a suitable value for a filter coefficient can be chosen at each time n, or at any suitable interval of time. However, in a further aspect of the disclosure, to avoid transients and potentially unstable system behavior, hysteresis may be built into the adaptation mechanism. That is, where a speed threshold is utilized to determine the filter coefficient, the value of the filter coefficient may remain the same even though the speed crossed the threshold, unless the speed is maintained on the other side of the threshold for a certain time (e.g., a predetermined interval), and/or the magnitude of the crossing of the threshold is greater than a certain amount (e.g., a predetermined amount). In this way, short-lived changes in a UE's speed crossing the threshold would not necessarily cause a change in the value of the filter coefficient, but longer-term, more sustained changes in the UE's speed would result in robust changes in the value of the filter coefficient to a more suitable value in accordance with the speed at which the UE is moving.

FIG. 8 is a flow chart illustrating an exemplary process 800 for selecting a signal power filter coefficient αₙ in accordance with an aspect of the disclosure utilizing hysteresis. Of course, the example only shows the selection of one filter coefficient αₙ, but in various examples the process may be utilized for both the signal power filter coefficient αₙ and the noise power filter coefficient βₙ, or for only one of the coefficients. In some examples, the process 800 of selecting a signal power filter coefficient αₙ may be performed by the signal power filter selector 608 or the noise power filter selector 610 illustrated in FIG. 6. In some examples, the process 800 of selecting a signal power filter coefficient αₙ may be performed by the processing system 114 illustrated in FIG. 1, the UE 310 illustrated in FIG. 3, or any one of the processors 490, 460, 470, 480, or 482 in the UE 450 illustrated in FIG. 4.

In one example, prior to the illustrated process, a counter may be initialized to a value of 0, or any other suitable value. The counter may be utilized to implement hysteresis in the process, i.e., to prevent frequent back and forth switching between the two filter coefficients α₁ and α₂. That is, if the counter falls below a low threshold, then the filter coefficient may be set to a first value α₁ corresponding to a low speed, and if the counter rises to a high threshold, then the filter coefficient may be set to a second value α₂ corresponding to a high speed. When the counter reaches the low threshold, if it is further decremented it may cycle back to the initial value of 0, or it may remain at the low threshold, depending on a design choice.

In some examples, the process 800 illustrated in FIG. 8 may be executed at each time interval n. In other examples, the process 800 may be executed at any suitable time interval in accordance with a design choice.

In block 802, the process determines whether the speed σ at which the UE is moving is greater than a suitable threshold value σₜₕᵣₑₛₕ. That is, the speed σ of the UE is considered to be “high” if it is above the threshold speed σₜₕᵣₑₛₕ, and “low” otherwise.

If no, then in block 804, the process may decrement the counter. In block 806, the process may determine whether the value of the counter is equal to the low threshold, −MAX. If no, then the process takes no action, setting the filter coefficient αₙ equal to its previous value αₙ₋₁, thus affecting the desired hysteresis. If yes, however, then in block 808 the filter coefficient αₙ is set to be equal to the first value α₁, wherein α₁ may be the filter coefficient utilized used for filtering one or both of the signal and noise powers at low UE speeds.

Returning to block 802, if the speed at which the UE is moving is greater than the threshold speed σₜₕᵣₑₛₕ, then in block 810, the counter may be incremented. In block 812, the process may determine whether the value of the counter is equal to the high threshold, +MAX. If no, then the process takes no action, setting the filter coefficient αₙ equal to its previous value αₙ₋₁, thus affecting the desired hysteresis. If yes, however, then in block 814 the filter coefficient αₙ is set to be equal to the second value α₂, wherein α₂ is the filter coefficient used for filtering one or both of the signal and noise powers at high UE speeds.

Of course, in various aspects of the disclosure, the method 800 can be generalized to allow for a finer classification of UE speeds and employing different filtering methods based on the output of the classification algorithm. Further, another simple form of hysteresis may affect a change in the filter coefficient only when the value of the speed crosses the threshold by an amount greater than some threshold in either direction. Those skilled in the art will recognize that any suitable form of hysteresis may be implemented in accordance with the present disclosure to modify the selection of a filter coefficient in accordance with one or more speed thresholds.

Several aspects of a telecommunications system have been presented with reference to a W-CDMA air interface. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication for user equipment, comprising:
generating a signal power estimate corresponding in part to a speed at which the user equipment moves;
generating a noise power estimate corresponding in part to the speed at which the user equipment moves;
generating a channel quality indicator corresponding to the signal power estimate and the noise power estimate; and
transmitting the channel quality indicator.

2. The method of claim 1, further comprising:
receiving a pilot signal,
wherein the signal power estimate further corresponds in part to the pilot signal, and
wherein the noise power estimate further corresponds in part to the pilot signal.

3. The method of claim 1, further comprising:
generating a signal-to-noise ratio corresponding to the signal power estimate and the noise power estimate,
wherein the generating of the channel quality indicator comprises mapping the generated signal-to-noise ratio to a CQI value utilizing a predetermined mapping protocol.

4. The method of claim 1, wherein the generating of the signal power estimate comprises: selecting a signal power filter coefficient corresponding to the speed at which the user equipment moves.

5. The method of claim 4, further comprising:
filtering a parameter corresponding to an amplitude of a received pilot symbol by utilizing an infinite impulse response filter having a pole corresponding to the signal power filter coefficient.

6. The method of claim 4, wherein the selecting of the signal power coefficient comprises selecting between a first value and a second value, the first value corresponding to the speed at which the user equipment moves being greater than a threshold, and the second value corresponding to the speed at which the user equipment moves being less than the threshold.

7. The method of claim 6, wherein the selecting of the signal power coefficient further comprises changing the signal power coefficient between the first value and the second value when the speed crosses the threshold and remains for a predetermined interval.

8. The method of claim 1, wherein the generating of the noise power estimate comprises:
selecting a noise power filter coefficient corresponding to the speed at which the user equipment moves.

9. The method of claim 8, further comprising: filtering a parameter corresponding to noise of a received pilot symbol sequence by utilizing an infinite impulse response filter having a pole corresponding to the noise power filter coefficient.

10. The method of claim 8, wherein the selecting of the noise power coefficient comprises selecting between a first value and a second value, the first value corresponding to the speed at which the user equipment moves being greater than a threshold, and the second value corresponding to the speed at which the user equipment moves being less than the threshold.

11. The method of claim 10, wherein the selecting of the noise power coefficient further comprises changing the noise power coefficient between the first value and the second value when the speed crosses the threshold and remains for a predetermined interval.

12. An apparatus for wireless communication, comprising:
means for generating a signal power estimate corresponding in part to a speed at which the apparatus moves;
means for generating a noise power estimate corresponding in part to the speed at which the apparatus moves;
means for generating a channel quality indicator corresponding to the signal power estimate and the noise power estimate; and
means for transmitting the channel quality indicator.

13. The apparatus of claim 12, further comprising:
means for receiving a pilot signal,
wherein the signal power estimate further corresponds in part to the pilot signal, and
wherein the noise power estimate further corresponds in part to the pilot signal.

14. The apparatus of claim 12, further comprising:
means for generating a signal-to-noise ratio corresponding to the signal power estimate and the noise power estimate,
wherein the means for generating the channel quality indicator comprises means for mapping the generated signal-to-noise ratio to a CQI value utilizing a predetermined mapping protocol.

15. The apparatus of claim 12, wherein the means for generating the signal power estimate comprises:
means for selecting a signal power filter coefficient corresponding to the speed at which the apparatus moves.

16. The apparatus of claim 15, further comprising:
means for filtering a parameter corresponding to an amplitude of a received pilot symbol by utilizing an infinite impulse response filter having a pole corresponding to the signal power filter coefficient.

17. The apparatus of claim 15, wherein the means for selecting the signal power coefficient comprises means for selecting between a first value and a second value, the first value corresponding to the speed at which the apparatus moves being greater than a threshold, and the second value corresponding to the speed at which the apparatus moves being less than the threshold.

18. The apparatus of claim 17, wherein the means for selecting the signal power coefficient further comprises means for changing the signal power coefficient between the first value and the second value when the speed crosses the threshold and remains for a predetermined interval.

19. The apparatus of claim 12, wherein the means for generating the noise power estimate comprises:
means for selecting a noise power filter coefficient corresponding to the speed at which the apparatus moves.

20. The apparatus of claim 19, further comprising:
means for filtering a parameter corresponding to noise of a received pilot symbol sequence by utilizing an infinite impulse response filter having a pole corresponding to the noise power filter coefficient.

21. The apparatus of claim 19, wherein the means for selecting the noise power coefficient comprises means for selecting between a first value and a second value, the first value corresponding to the speed at which the apparatus moves being greater than a threshold, and the second value corresponding to the speed at which the apparatus moves being less than the threshold.

22. The apparatus of claim 21, wherein the means for selecting the noise power coefficient further comprises means for changing the noise power coefficient between the first value and the second value when the speed crosses the threshold and remains for a predetermined interval.

23. A computer program product for user equipment, comprising:
a computer-readable medium, comprising:
instructions for causing a computer to generate a signal power estimate corresponding in part to a speed at which the user equipment moves;
instructions for causing a computer to generate a noise power estimate corresponding in part to the speed at which the user equipment moves;
instructions for causing a computer to generate a channel quality indicator corresponding to the signal power estimate and the noise power estimate; and
instructions for causing a computer to transmit the channel quality indicator.

24. The computer program product of claim 23, wherein the computer-readable medium further comprises:
instructions for causing a computer to receive a pilot signal,
wherein the signal power estimate further corresponds in part to the pilot signal, and
wherein the noise power estimate further corresponds in part to the pilot signal.

25. The computer program product of claim 23, wherein the computer-readable medium further comprises:
instructions for causing a computer to generate a signal-to-noise ratio corresponding to the signal power estimate and the noise power estimate,
wherein the instructions for causing a computer to generate the channel quality indicator comprise instructions for causing a computer to map the generated signal-to-noise ratio to a CQI value utilizing a predetermined mapping protocol.

26. The computer program product of claim 23, wherein the instructions for causing a computer to generate the signal power estimate comprise:
instructions for causing a computer to select a signal power filter coefficient corresponding to the speed at which the user equipment moves.

27. The computer program product of claim 26, wherein the computer-readable medium further comprises:
instructions for causing a computer to filter a parameter corresponding to an amplitude of a received pilot symbol by utilizing an infinite impulse response filter having a pole corresponding to the signal power filter coefficient.

28. The computer program product of claim 26, wherein the instructions for causing a computer to select the signal power coefficient comprise instructions for causing a computer to select between a first value and a second value, the first value corresponding to the speed at which the user equipment moves being greater than a threshold, and the second value corresponding to the speed at which the user equipment moves being less than the threshold.

29. The computer program product of claim 28, wherein the instructions for causing a computer to select the signal power coefficient further comprise instructions for causing a computer to change the signal power coefficient between the first value and the second value when the speed crosses the threshold and remains for a predetermined interval.

30. The computer program product of claim 23, wherein the instructions for causing a computer to generate the noise power estimate comprise:
instructions for causing a computer to select a noise power filter coefficient corresponding to the speed at which the user equipment moves.

31. The computer program product of claim 30, wherein the computer-readable medium further comprises:
instructions for causing a computer to filter a parameter corresponding to noise of a received pilot symbol sequence by utilizing an infinite impulse response filter having a pole corresponding to the noise power filter coefficient.

32. The computer program product of claim 30, wherein the instructions for causing a computer to select the noise power coefficient comprise instructions for causing a computer to select between a first value and a second value, the first value corresponding to the speed at which the user equipment moves being greater than a threshold, and the second value corresponding to the speed at which the user equipment moves being less than the threshold.

33. The computer program product of claim 32, wherein the instructions for causing a computer to select the noise power coefficient further comprise instructions for causing a computer to change the noise power coefficient between the first value and the second value when the speed crosses the threshold and remains for a predetermined interval.

34. An apparatus for wireless communication, comprising:
at least one processor; and
a memory coupled to the at least one processor,
wherein the at least one processor is configured to:
generate a signal power estimate corresponding in part to a speed at which the apparatus moves;
generate a noise power estimate corresponding in part to the speed at which the apparatus moves;
generate a channel quality indicator corresponding to the signal power estimate and the noise power estimate; and
transmit the channel quality indicator.

35. The apparatus of claim 34, wherein the at least one processor is further configured to:
receive a pilot signal,
wherein the signal power estimate further corresponds in part to the pilot signal, and
wherein the noise power estimate further corresponds in part to the pilot signal.

36. The apparatus of claim 34, wherein the at least one processor is further configured to:
generate a signal-to-noise ratio corresponding to the signal power estimate and the noise power estimate,
wherein the generating of the channel quality indicator comprises mapping the generated signal-to-noise ratio to a CQI value utilizing a predetermined mapping protocol.

37. The apparatus of claim 34, wherein the generating of the signal power estimate comprises:
selecting a signal power filter coefficient corresponding to the speed at which the apparatus moves.

38. The apparatus of claim 37, wherein the at least one processor is further configured to:
filter a parameter corresponding to an amplitude of a received pilot symbol by utilizing an infinite impulse response filter having a pole corresponding to the signal power filter coefficient.

39. The apparatus of claim 37, wherein the selecting of the signal power coefficient comprises selecting between a first value and a second value, the first value corresponding to the speed at which the apparatus moves being greater than a threshold, and the second value corresponding to the speed at which the apparatus moves being less than the threshold.

40. The apparatus of claim 39, wherein the selecting of the signal power coefficient further comprises changing the signal power coefficient between the first value and the second value when the speed crosses the threshold and remains for a predetermined interval.

41. The apparatus of claim 34, wherein the generating of the noise power estimate comprises:
selecting a noise power filter coefficient corresponding to the speed at which the apparatus moves.

42. The apparatus of claim 41, wherein the at least one processor is further configured to:
filter a parameter corresponding to noise of a received pilot symbol sequence by utilizing an infinite impulse response filter having a pole corresponding to the noise power filter coefficient.

43. The apparatus of claim 41, wherein the selecting of the noise power coefficient comprises selecting between a first value and a second value, the first value corresponding to the speed at which the apparatus moves being greater than a threshold, and the second value corresponding to the speed at which the apparatus moves being less than the threshold.

44. The apparatus of claim 43, wherein selecting of the noise power coefficient further comprises changing the noise power coefficient between the first value and the second value when the speed crosses the threshold and remains for a predetermined interval.
